(19) United States
(12) Patent Application Publication
(10) Pub. No.: US 2014/0164569 A1
(43) Pub. Date: Jun. 12, 2014

(54) COMMUNICATION APPARATUS AND METHOD FOR CONTROLLING THE SAME

(71) Applicant: CANON KABUSHIKI KAISHA, Tokyo (JP)

(72) Inventor: Masashi Yoshida, Miura-gun (JP)

(73) Assignee: CANON KABUSHIKI KAISHA, Tokyo (JP)

(21) Appl. No.: 14/096,744

(22) Filed: Dec. 4, 2013

(30) Foreign Application Priority Data
Dec. 7, 2012 (JP) 2012-268541

(51) Int. Cl. H04L 29/08

(52) U.S. Cl. CPC H04L 67/10
USPC 709/218; 709/217

(57) ABSTRACT

A method for controlling a communication apparatus capable of participating in a network formed by a relay apparatus, receiving a notification indicating whether the data processing apparatus has formed a first network as the relay apparatus; searching, when the notification indicating that the data processing apparatus has formed the first network as the relay apparatus is received and data is transmitted or received via the Internet, for surrounding networks, eliminating the first network from a search result, and participating in one of remaining candidates.

### BACKGROUND OF THE INVENTION

1. Field of the Invention

The present invention relates to a technology for communicating with other devices via a network.

2. Description of the Related Art

As discussed in Japanese Patent Application Laid-Open No. 2007-166577, there is known a technology for mounting a wireless communication function on a data processing apparatus such as a digital camera, and transmitting image data stored in the data processing apparatus to an external apparatus. The use of this function enables the image data to be transmitted to the external apparatus more readily.

Recently, there has been known a technology that includes a simple access point function in a digital camera. When the digital camera activates its simple access point function, another apparatus detects the digital camera as an access point to participate in a network formed by the digital camera. This facilitates communication between the digital camera and another apparatus.

### SUMMARY OF THE INVENTION

According to an aspect of the present invention, a communication apparatus capable of participating in a network formed by a relay apparatus, includes: a data communication unit configured to perform data communication with a data processing apparatus by establishing communication with the data processing apparatus via a first network; a reception unit configured to receive, from the data processing apparatus, a notification indicating whether the data processing apparatus has formed the first network as the relay apparatus; a control unit configured to control transmission or reception of data via the Internet; and a switching unit configured to search, when the notification indicating that the data processing apparatus has formed the first network as the relay apparatus is received, for surrounding networks, eliminate the first network from a search result, and switch connection to one of remaining candidates. The control unit transmits or receives data via the Internet by using the switched network.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of a digital camera according to a first exemplary embodiment.

FIG. 2 is a block diagram illustrating a configuration of a mobile phone according to the first exemplary embodiment.

FIGS. 3A and 3B are diagrams each illustrating a network configuration according to the first exemplary embodiment.

FIG. 4 is a flowchart illustrating an operation of the digital camera according to the first exemplary embodiment.

FIGS. 5A-5F are diagrams each illustrating a display screen according to the first exemplary embodiment.

FIGS. 5G-5H are flowcharts each illustrating an operation of the mobile phone according to the first exemplary embodiment.

FIGS. 6A and 6B are flowcharts each illustrating an operation of the mobile phone according to the first exemplary embodiment.

FIGS. 7A to 7I are diagrams each illustrating a display screen according to the first exemplary embodiment.

FIG. 8 is a flowchart illustrating an operation of the digital camera according to the first exemplary embodiment.

FIGS. 9A and 9B are diagrams each illustrating an operation according to the first exemplary embodiment.

FIG. 10 is a diagram illustrating an operation according to the first exemplary embodiment.

FIGS. 11A and 11B are diagrams each illustrating a display screen according to a second exemplary embodiment.

FIG. 12 is a flowchart illustrating an operation of a mobile phone according to the second exemplary embodiment.

### DESCRIPTION OF THE EMBODIMENTS

Various exemplary embodiments, features, and aspects of the invention will be described in detail below with reference to the drawings.

### Configuration of Digital Camera

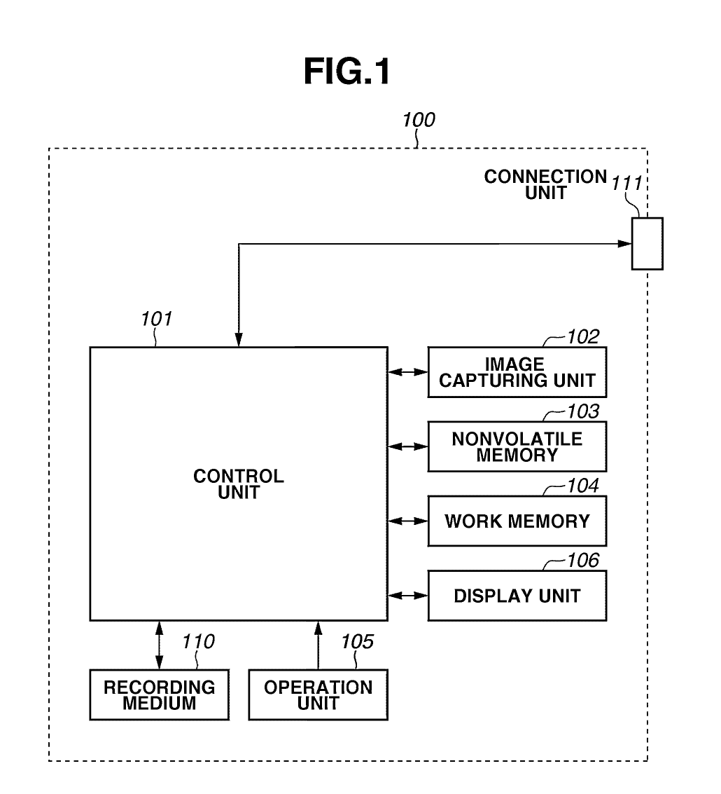

FIG. 1 is a block diagram illustrating a configuration of a digital camera 100 as an example of a data processing apparatus according to a first exemplary embodiment. While in the present case, the digital camera is described as the example of the data processing apparatus, the data processing apparatus is not limited to the digital camera. For example, the data processing apparatus can be a mobile media player or an information processing apparatus such as a tablet device or a personal computer.

A control unit 101 controls each component of the digital camera 100 according to an input signal or a program described below. In place of control by the control unit 101, the entire apparatus can be controlled by sharing the processing among a plurality of hardware units.

An image capturing unit 102 converts object light image formed by a lens included in the image capturing unit 102 into an electric signal, and subjects the signal to noise reduction processing to output digital data as image data. The captured image data is stored in a buffer memory, and then subjected to predetermined calculation in the control unit 101 to be recorded in a recording medium 110.

A nonvolatile memory 103, which is an electrically erasable/recordable nonvolatile memory, stores the program described below, which is executed by the control unit 101.

A work memory 104 is used as a buffer memory for temporarily storing the image data captured by the image capturing unit 102, an image display memory of a display unit 106, or a work region of the control unit 101.

An operation unit 105 is used for receiving an instruction to the digital camera 100 from a user. The operation unit 105 includes an operation member such as a power button used by the user for instructing ON/OFF of the digital camera 100, a release switch used for instructing photographing, or a play button used for instructing reproduction of the image data. A touch panel formed on the display unit 106 described below is also included in the operation unit 105. The release switch includes switches SW1 and SW2. The switch SW1 is turned ON by half-pressing the release switch. Accordingly, an instruction to make photographing preparation such as auto-focus (AF) processing, auto-exposure (AE) processing, auto-white balance (AWB) processing, or flash preemission (EF) processing is received. The switch SW2 is turned ON by fully pressing the release switch. Accordingly, a photographing instruction is received.

The display unit 106 displays a viewfinder image during photographing, the captured image data, or a character for a dialog operation. The digital camera 100 is not always required to include the display unit 106. The digital camera 100 is only required to have a display control function of connecting with the internal or external display unit 106 to control displaying of the display unit 106.

The image data output from the image capturing unit 102 can be recorded in the recording medium 110. The recording medium 110 can be detachably attached to the digital camera 100 or incorporated in the digital camera 100. In other words, the digital camera 100 is required to include at least a unit for accessing the recording medium 110.

A connection unit 111 is an interface for connection with an external apparatus. The digital camera 100 according to the present exemplary embodiment can exchange data with the external apparatus via the connection unit 111. In the present exemplary embodiment, the connection unit 111 includes an interface for performing communication with the external apparatus via a wireless local area network (LAN). The control unit 101 realizes wireless communication with the external apparatus by controlling the connection unit 111. A communication method is not limited to the wireless LAN.

The digital camera 100 according to the present exemplary embodiment can operate as a slave apparatus in an infrastructure mode. When operated as the slave apparatus, the digital camera 100 can participate in a network formed by a surrounding access point (AP) by connecting to the AP. The digital camera 100 according to the present exemplary embodiment can also operate as a simple AP that is a type of AP but more limited in function, for example, a microaccess point. The AP in the present exemplary embodiment is an example of a relay apparatus. When the digital camera 100 operates as the simple AP, the digital camera 100 forms a network by itself. An apparatus around the digital camera 100 recognizes the digital camera 100 as the AP, and can participate in the network formed by the digital camera 100. The program for operating the digital camera 100 this way is stored in the nonvolatile memory 103.

The digital camera 100 according to the present exemplary embodiment, which is a type of AP, is a simple AP having no gateway function of transferring data received from the slave apparatus to an Internet provider. Thus, even when it receives data from another apparatus participating in the network formed by itself, the digital camera 100 cannot transfer the data to a network such as the Internet.

The digital camera 100 has been described. Next, a portable phone 200 that is an example of an external apparatus will be described.

### Configuration of Mobile Phone

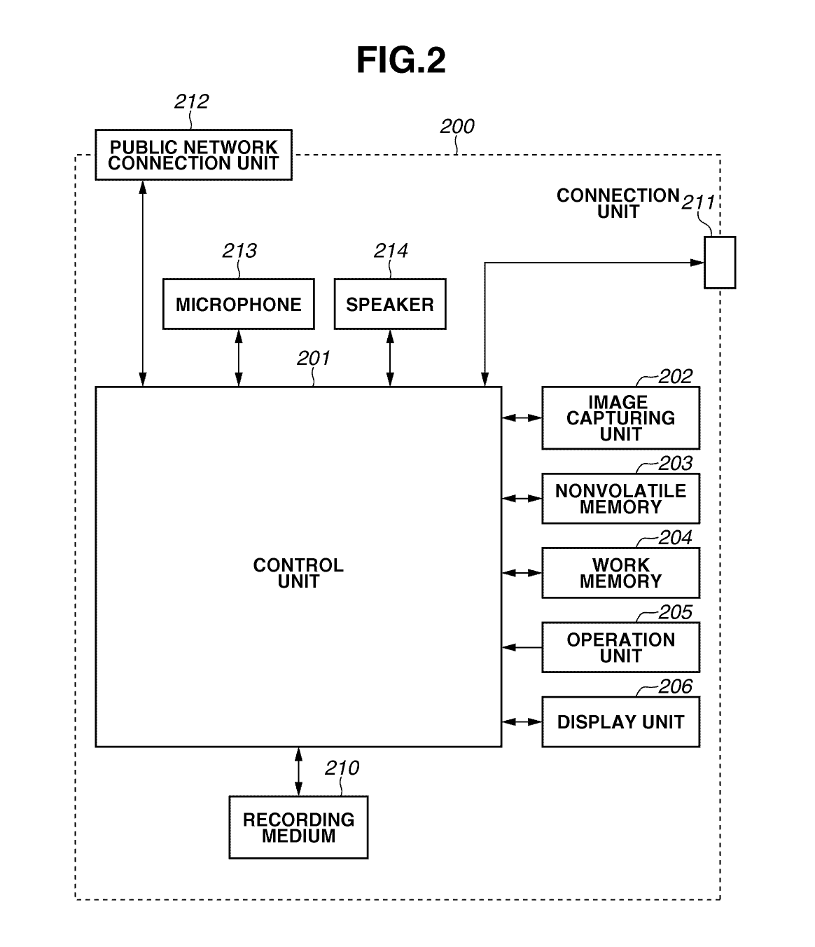

FIG. 2 is a block diagram illustrating a configuration example of the mobile phone 200 that is an example of a communication apparatus according to the present exemplary embodiment. While the mobile phone will be described as the example of the communication apparatus in the present case, the communication apparatus is not limited to the mobile phone. For example, the communication apparatus can be a digital camera having a wireless function, a mobile media player, or an information processing apparatus such as a tablet device, a personal computer, or a smartphone.

A control unit 201 controls each component of the mobile phone 200 according to an input signal or a program described below. In place of control by the control unit 201, the entire apparatus can be controlled by sharing the processing among a plurality of hardware units.

An image capturing unit 202 converts object light image formed by a lens included in the image capturing unit 102 into an electric signal, and subjects the signal to noise reduction processing to output digital data as image data. The captured image data is stored in a buffer memory, and then subjected to predetermined calculation in the control unit 201 to be recorded in a recording medium 210.

A nonvolatile memory 203, which is an electrically erasable/recordable nonvolatile memory, stores various programs to be executed by the control unit 201. A program for communication with the digital camera 100 is also stored in the nonvolatile memory 203, and installed as a camera communication application. Processing of the mobile phone 200 in the present exemplary embodiment is realized by reading the program provided by the camera communication application. The camera communication application has a program for using a basic function of an operating system (OS) installed in the mobile phone 200. The OS of the mobile phone 200 can include a program for realizing processing of the present exemplary embodiment.

A work memory 204 is used as a buffer memory for temporarily storing the image data captured by the image capturing unit 102, an image display memory of a display unit 206, or a work region of the control unit 201.

An operation unit 205 is used for receiving an instruction to the mobile phone 200 from a user. The operation unit 205 includes an operation member such as a power button used by the user for instructing power ON/OFF of the mobile phone 200 or a touch panel formed on the display unit 206.

The display unit 206 displays the image data or a character for a dialog operation. The mobile phone 200 is not always required to include the display unit 206. The mobile phone 200 is only required to have a display control function of connecting with the display unit 206 to control displaying of the display unit 206.

The image data output from the image capturing unit 202 can be recorded in the recording medium 210. The recording medium 210 can be detachably attached to the mobile phone 200 or incorporated in the mobile phone 200. In other words, the mobile phone 200 is only required to include at least a unit for accessing the recording medium 210.

A connection unit 211 is an interface for connection with an external apparatus. The mobile phone 200 according to the present exemplary embodiment can exchange data with the external apparatus via the connection unit 211. In the present exemplary embodiment, the connection unit 211 includes an interface for performing communication with the external apparatus via a wireless LAN. The control unit 201 realizes wireless communication with the external apparatus by controlling the connection unit 211. The mobile phone 200 according to the present exemplary embodiment can operate at least as a slave apparatus in the infrastructure mode, and participate in a network formed by a surrounding AP.

A public network connection unit 212 is an interface for performing public wireless communication. The mobile phone 200 can make a call to or perform data communication with another device. During phone call, the control unit 201 inputs or outputs an audio signal via a microphone 213 or a speaker 214. In the present exemplary embodiment, the public network connection unit 212 includes an interface for performing communication by using 3rd Generation (3G) cell-phone. However, the communication method is not limited to the 3G, other communication methods such as 4G, i.e., Long Term Evolution (LTE), image Maximum (iMAX), Asymmetric Digital Subscriber Line (ADSL), or Fiber to the Home (FTTH), can be used. The connection unit 211 and the public network connection unit 213 are not necessarily configured by using independent hardware units. For example, one antenna can be used being shared. The mobile phone 200 has been described.

### Outline of Connection Form

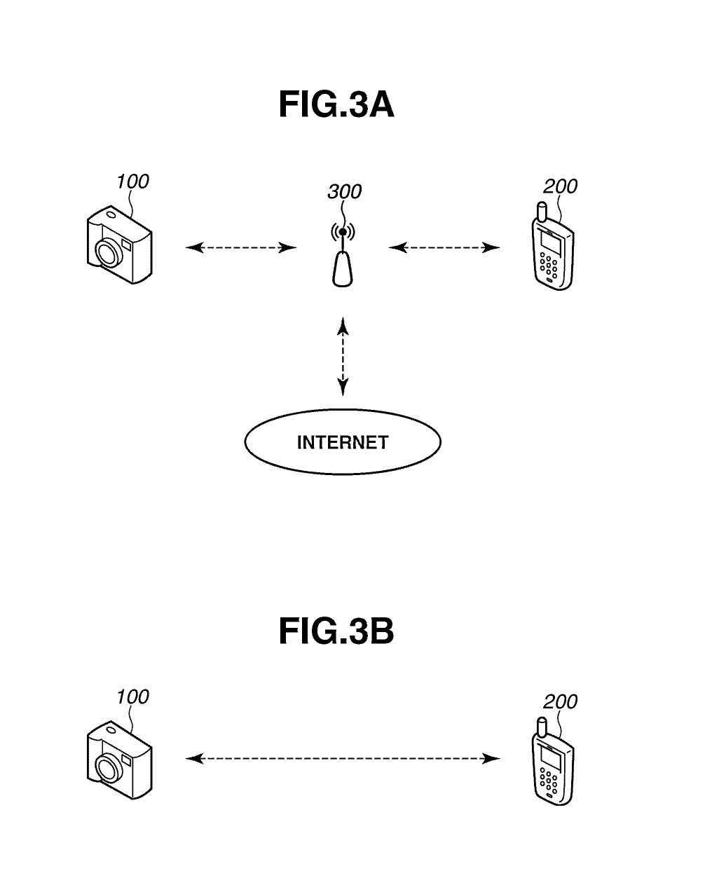

FIGS. 3A and 3B are diagrams each schematically illustrating a connection form between the digital camera 100 and the mobile phone 200 according to the present exemplary embodiment. When the digital camera 100 and the mobile phone 200 transfer data with each other by wireless, two connection forms illustrated in FIGS. 1A and 1B are conceivable.

FIG. 3A illustrates a form where the digital camera 100 and the mobile phone 200 participate in a wireless LAN formed by an external AP 300 as an example of an external relay apparatus. The digital camera 100 and the mobile phone 200 detect a beacon signal periodically transmitted from the external AP 300 to participate in the wireless LAN formed by the external AP 300. The digital camera 100 and the mobile phone 200, which have participated in the same wireless LAN, can transfer data via the wireless LAN (establish communication between devices) after each other's devices are discovered and device capacity is acquired.

The external AP 300 in the present exemplary embodiment can connect to an external network such as the Internet by using a public network. Accordingly, the mobile phone 200 can transmit data to the Internet via the external AP 300.

FIG. 3B illustrates a form where the digital camera 100 and the mobile phone 200 are directly connected to each other not via the external AP 300. In this case, the digital camera 100 operates as a simple AP to form a wireless LAN. The digital camera 100, which operates as the simple AP, starts periodic transmission of beacon signals. The mobile phone 200 detects a beacon signal to participate in the wireless LAN formed by the digital camera 100. As in the case illustrated in FIG. 3A, the digital camera 100 and the mobile phone 200 establish communication with each other after each other's devices are discovered and device capacity is acquired, and thus can transfer data.

As described above, the digital camera 100 according to the present exemplary embodiment has no communication function with an external network such as the Internet. Thus, the mobile phone 200 participating in the wireless LAN formed by the digital camera 100 cannot transmit data to the Internet via the simple AP.

As described above, there are two connection forms between the digital camera 100 and the mobile phone 200. In the present exemplary embodiment, an example of performing appropriate control depending on these connection forms will be described.

### Connection Form

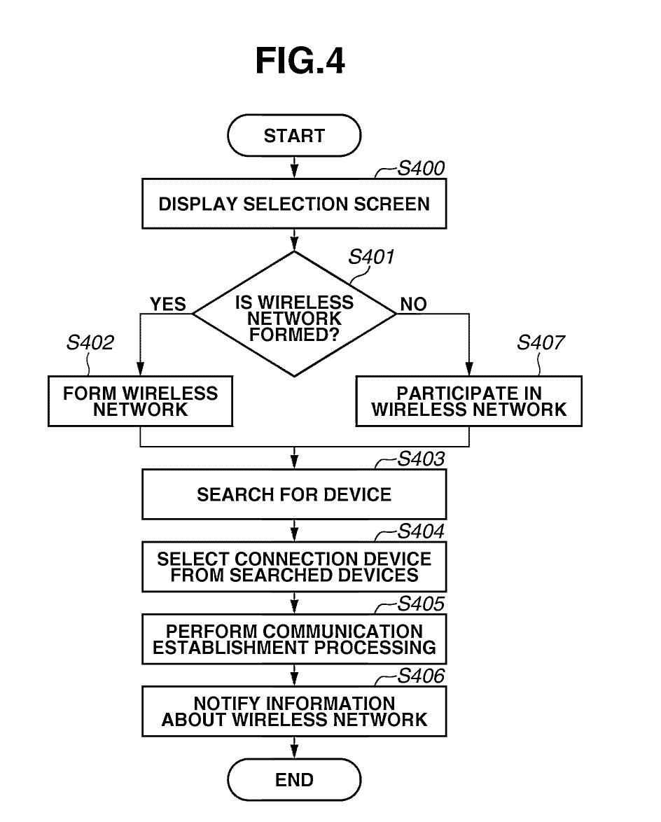

FIG. 4 is a flowchart illustrating processing of the digital camera 100 when it is connected to the mobile phone 200. The processing of the flowchart is realized by the control unit 101 of the digital camera 100 controlling each unit of the digital camera 100 according to an input signal or a program. Unless otherwise specified, the same applies to other flowcharts concerning processing of the digital camera 100. The processing of this flowchart is started when the user of the digital camera 100 instructs connection to another apparatus by a menu operation.

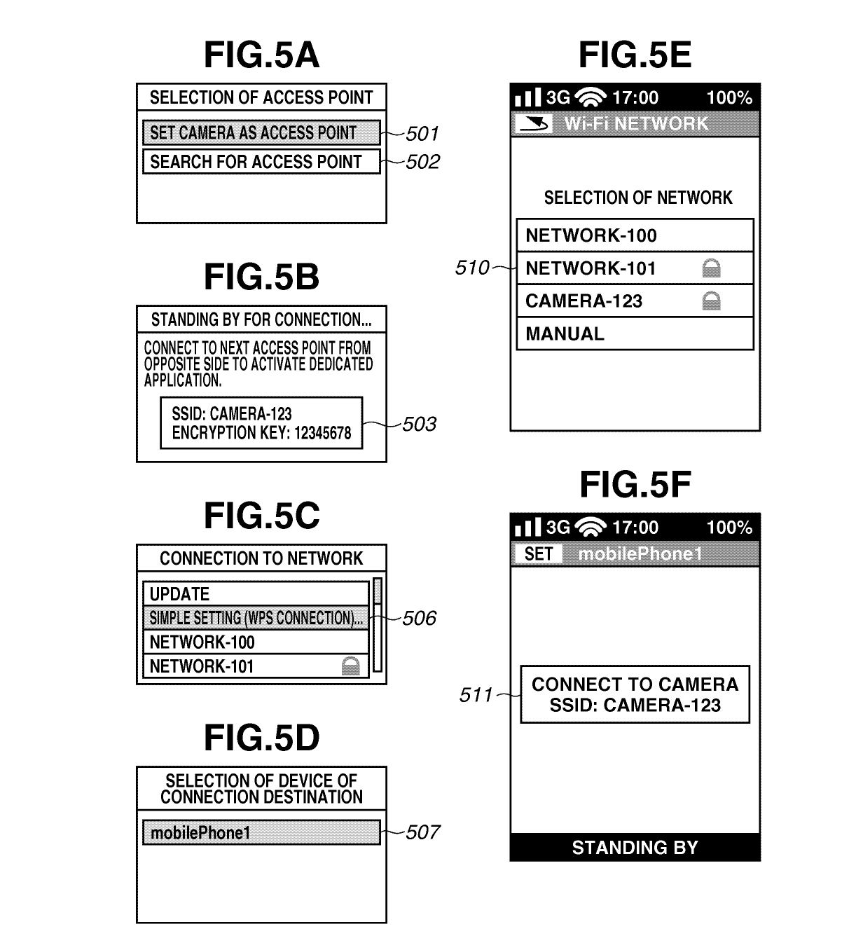

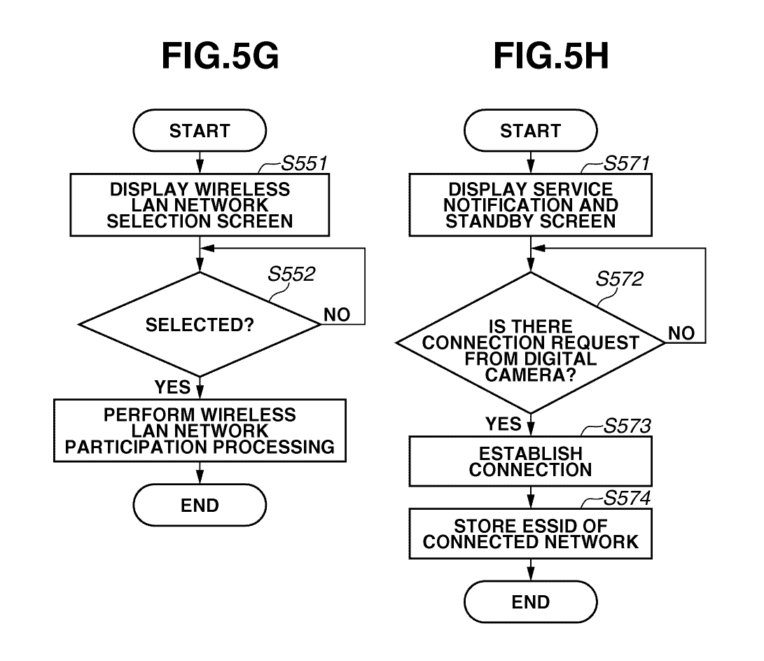

In step S400, the control unit 101 displays a screen for selecting participation in a wireless LAN formed by an external AP or an operation of the own apparatus as a simple AP, on the display unit 106. FIG. 5A(a) illustrates an example of the screen displayed in this step.

When it is determined that a button 501 has been selected by a user's operation (YES in S401), the control unit 501 determines that formation of a wireless LAN has been selected, and the processing proceeds to step S402. When it is determined that a button 502 has been selected by a user's operation (NO in S401), the control unit 501 determines that participation in the wireless LAN formed by the external AP has been selected, and the processing proceeds to step S407.

In step S402, the control unit 101 forms a wireless LAN. Specifically, the control unit 101 generates Extended Service Set Identifier (ESSID), Basic Service Set Identifier (BSSID), an authentication method, an encryption type, and an encryption key necessary for forming a network. The control unit 101 displays at least the ESSID and the encryption key as communication parameters needed by a connection device to participate in the network on the display unit 106. FIG. 5A(b) illustrates an example of the display. In the example illustrated in FIG. 5A(b), as in indicated in a dialog 503, the ESSID is determined to be “CAMERA-123”, and the encryption key is determined to be “12345678”. The encryption key and the ESSID can be generated for each connection process or each connection device, or always of a similar type. In this step, to enable communication with the other device, the control unit 101 allocates an Internet Protocol (IP) address, and sets a sub-network, and then the processing proceeds to step S403.

On the other hand, if the processing proceeds to step S407, the control unit 101 scans a surrounding wireless LAN, and displays a list of ESSIDs included in a beacon signal detected as a result on the display unit 106. FIG. 5A(c) illustrates an example of a screen in this case. In the example illustrated in FIG. 5A(c), ESSIDs of “NETWORK-100” and “NETWORK-101” are detected. When the wireless LAN has been selected from a list 506 illustrated in FIG. 5A(c) by a user's operation, the control unit 101 participates in the selected wireless LAN, in other words, performs connection processing to the AP. Further, to enable communication with the other device, the control unit 101 performs IP address allocation and subnetwork setting, and the processing proceeds to step S403.

In step S403, the control unit 101 searches for devices connectable in the same network. To enable the digital camera 100 to search for the mobile phone 200, an operation is necessary on the mobile phone 200 side. Hereinafter, referring to FIGS. 5A(a) to 5A(f), and FIGS. 5B(a) and 5B(b), the operation on the mobile phone side 200 will be described. FIGS. 5B(a) and 5B(b) are flowcharts illustrating processing of the mobile phone 200 according to the present exemplary embodiment. The processing of the flowchart is realized by the control unit 201 of the mobile phone 200 controlling each unit of the mobile phone 200 according to an input signal or a program. Unless otherwise specified, the other flowchart indicating processing of the mobile phone 200 is similar.

First, in step S551, in response to a predetermined operation performed by the user of the mobile phone 200, the control unit 201 displays, on the display unit 206, a screen for selecting a wireless LAN for participation. After having changed to the screen, the control unit 201 scans a surrounding wireless LAN, and displays a list 510 of ESSIDs detected as a result. FIG. 5A(e) illustrates an example of the screen. In the present exemplary embodiment, these processes are performed by the function of the OS of the mobile phone 200 before activation of the camera communication application. However, the camera communication application activated beforehand can perform the processes cooperatively with the function of the OS. When the digital camera 100 operates as a simple AP, the mobile phone 200 detects ESSID of the digital camera 100 to display it in the list 510. In FIG. 5A(e), “CAMERA-123” is displayed as ESSID of the digital camera 100.

In step S552, the control unit 201 stands by waiting for selection of any one of ESSIDs in the list 510. After any one of ESSIDs has been selected from the list 510 by a user's operation, in step S553, the control unit 210 performs participation processing in a corresponding wireless LAN. This completes participation in the network.

After the participation in the network, the user of the mobile phone 200 activates the camera communication application installed in the mobile phone 200. Processing of the mobile phone 200 after the camera communication application has been activated will be described referring to a flowchart illustrated in FIG. 5B(b). Main functions of the camera communication application include a function of establishing communication with a digital camera present in the same network, a function of transferring content data such as image data, and a function of controlling processing for transmitting content data of its own device to a server.

After the camera communication application has been activated by the user's operation, in step S571, a standby screen similar to that illustrated in FIG. 5A(f) is displayed on the display unit 206. In a dialog 511, ESSID of a network of current participation is displayed. In an example illustrated in FIG. 5A(f), “CAMERA-123” is selected on the screen illustrated in FIG. 5A(e). After the activation of the camera communication application, service notification of the own device is performed via the wireless LAN so that the digital camera 100 can detect the mobile phone 200. The digital camera 100 can detect the mobile phone 200 based on the service notification. The service notification includes a device name and Universally Unique Identifier (UUID) of the mobile phone 200. In step S572, the control unit 201 stands by waiting for a connection request from the digital camera 100. When it is determined that there is a connection request (YES in step S572), in step S573, communication with the digital camera 100 is established. Then, in step S574, the control unit 201 stores the ESSID of the connected network in the work memory 204.

Referring back to FIG. 4, in step S403, the control unit 101 searches for connectable devices present in the same network. As described above, if the service notification has been performed on the mobile phone 200 side, the digital camera 100 can detect the mobile phone 200. When a connectable device is detected as a result of the searching, the control unit 101 displays a device name included in the service notification in the list on the display unit 106. FIG. 5A(d) illustrates an example of the list displaying. The UUID and the device name included in the service notification are associated with each other to be stored in the work memory 104.

In the present exemplary embodiment, the service notification includes the device name and the UUID. However, a configuration where the digital camera 100 that has received the service notification makes inquiries about the device name and the UUID to the mobile phone 200 can be employed.

In step S404, the control unit 101 receives a user's operation for selecting one of the device names displayed in the list in step S403.

In step S405, the control unit 101 transmits a connection request to the mobile phone 200 by using the UUID of the device selected in step S404, and starts processing for establishing communication with the selected device. In the present exemplary embodiment, connection is performed by using the UUID of the opposite device. However, the connection can be made by specifying an IP address or a port number from the UUID, or an IP address can be obtained at the time of searching. After the communication has been established, the processing proceeds to step S406.

In step S406, the control unit 101 notifies the mobile phone 200 which has established communication in step S405, by indicating whether the wireless LAN of current participation has been formed by a simple AP. Specifically, when the own device functions as a simple AP, and the mobile phone 200 is participating in the wireless LAN of the own device, the digital camera 100 notifies the mobile phone 200 that the wireless LAN is formed by the own device. On the other hand, when the mobile phone 200 is participating in a wireless LAN formed by the other device, the digital camera 100 notifies the mobile phone 200 of nonformation of the wireless LAN by the own device. Through this notification, the mobile phone 200 can determine whether it is participating in the wireless LAN formed by the digital camera 100 or the wireless LAN formed by the other AP. Based on this notification, the mobile phone 200 can determine whether communication can be performed from the wireless LAN in which the own device is participating, to an external network.

### Operation After Connection

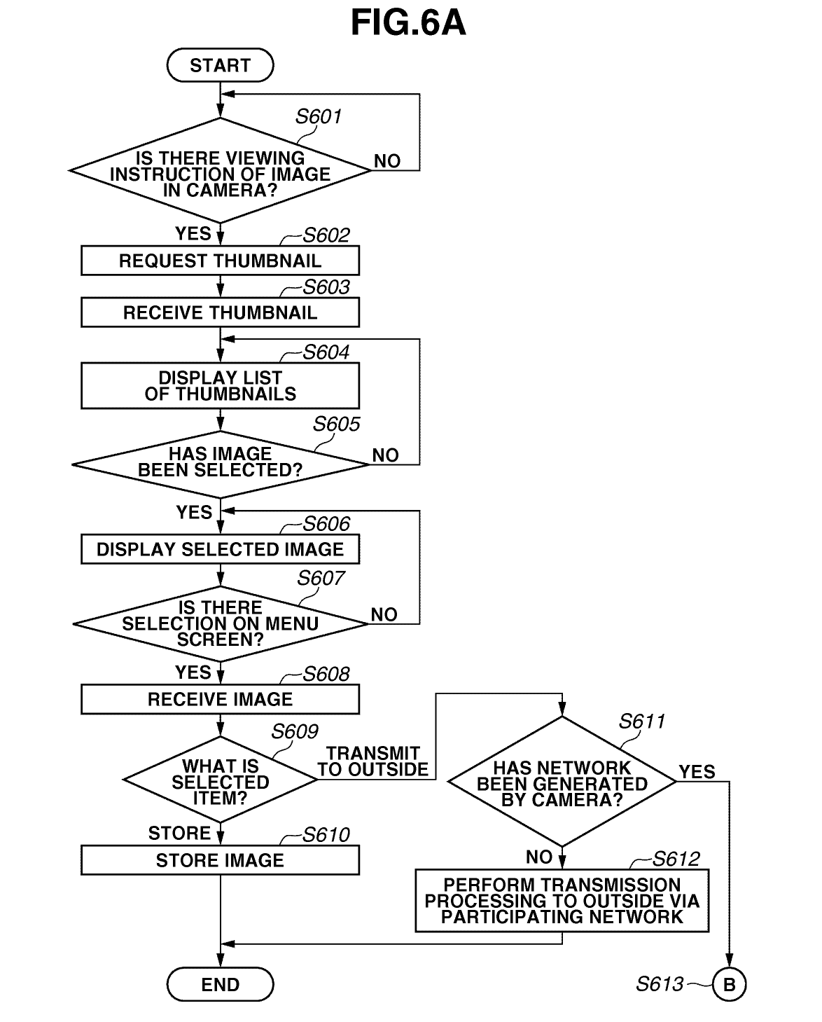

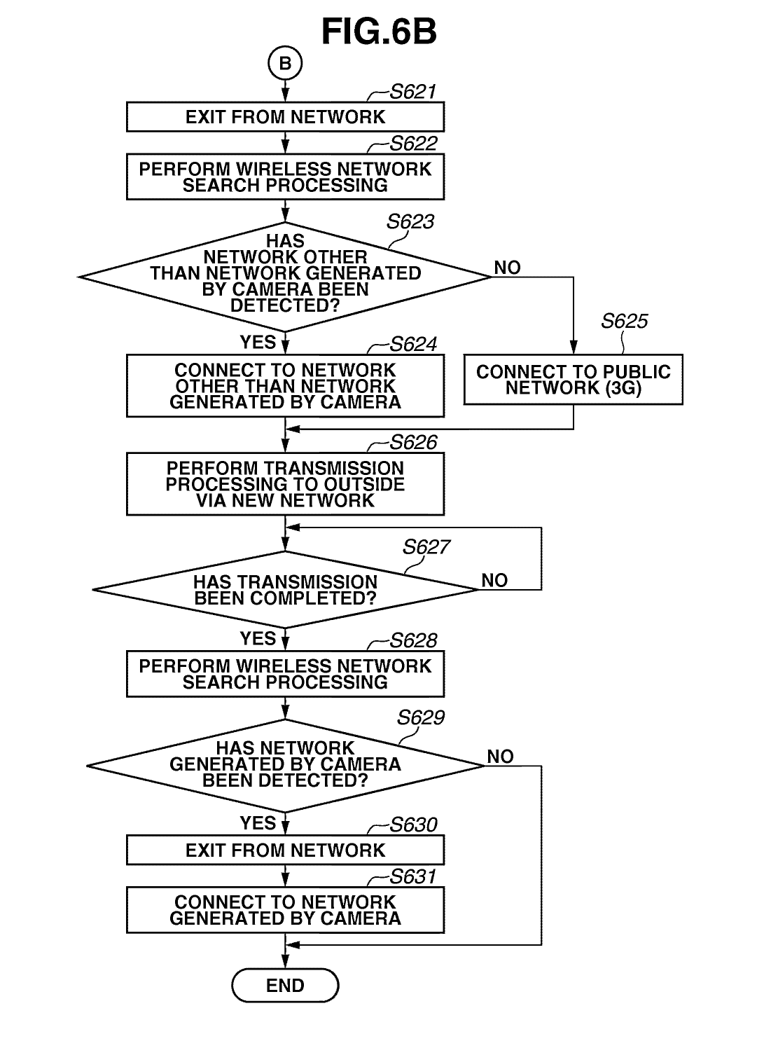

FIGS. 6A and 6B are flowcharts each illustrating the operation of the mobile phone 200 after the communication with the digital camera 100 has been established.

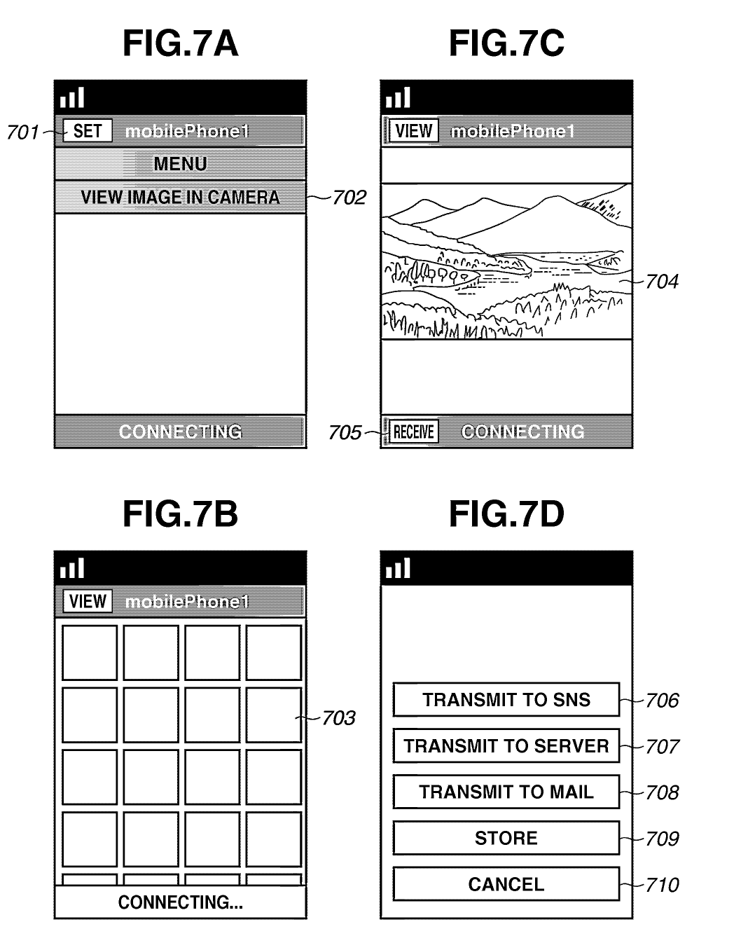

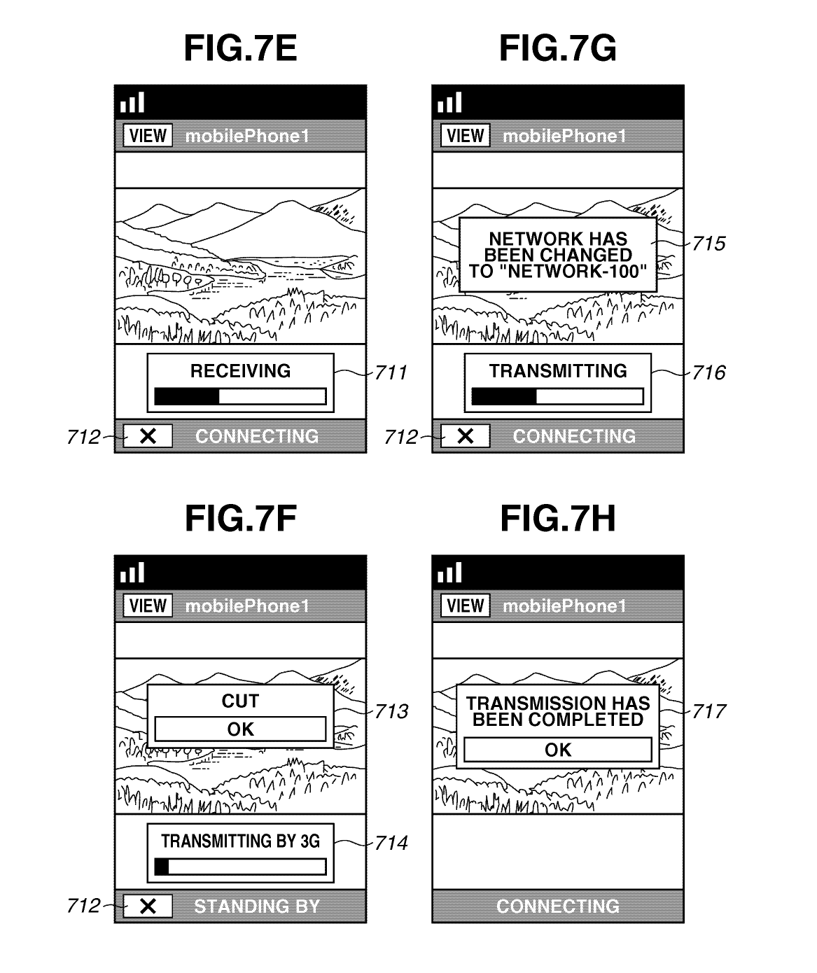

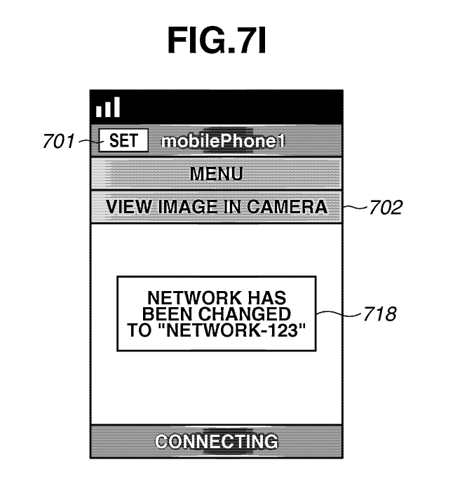

After the communication with the digital camera 100 has been established, the control unit 201 of the mobile phone 200 displays a menu screen of the camera communication application illustrated in FIG. 7A. A setting button 701 and a viewing button 702 are displayed on the menu screen. The setting button 701 is a button for setting a device name of the mobile phone 200 or performing various setting operations in uploading. The viewing button 702 is a button for displaying image data stored in the digital camera 100 with which the communication has been established on the display unit 206.

In step S601, the control unit 101 determines whether the viewing button 702 has been selected. When it is determined that the viewing button 702 has been selected (YES in step S601), the processing proceeds to step S602. When it is determined that the viewing button 702 has not been selected (NO in step S601), the processing is repeated.

In step S602, the control unit 201 makes a request to the digital camera 100 for thumbnails of image data owned by the digital camera 100. In response to the request, the digital camera 100 transmits the requested thumbnails to the mobile phone 200. The thumbnails can be repeatedly requested thumbnails one by one, or a command for collectively requesting a plurality of thumbnails can be transmitted.

In step S603, the mobile phone 200 receives the thumbnails transmitted from the digital camera 100 via the connection unit 211 of the mobile phone 200.

In step S604, the control unit 201 displays a list of the received thumbnails on the display unit 206. FIG. 7B illustrates an example of a display screen. In the example illustrated in FIG. 7B, the thumbnails are displayed in four columns, and other image data can be displayed by a vertical scroll operation.

In step S605, the control unit 201 determines whether any one of the displayed list of thumbnails has been selected. When it is determined that one has been selected (YES in step S605), the processing proceeds to step S606. When otherwise (NO in step S605), the processing returns to step S604.

In step S606, the control unit 201 displays the selected thumbnail in a large size. FIG. 7C illustrates an example of displaying. As illustrated in FIG. 7C, the selected thumbnail is displayed in a size larger than that illustrated in FIG. 7B. The selected thumbnail is directly displayed in the larger size in step S606. However, in view of displaying with a larger size, a larger thumbnail or the image data can be requested to the digital camera 100 again.

The screen illustrated in FIG. 7C includes a receiving button 705. The receiving button 705 is a button for receiving the image data corresponding to the displayed thumbnail from the digital camera 100, and performing predetermined processing on the received image data. The processing will specifically be described below.

When the button 705 is selected by a user's operation, the control unit 201 translucently displays a menu illustrated in FIG. 7D and superimposed on the image data. Hereinafter, buttons included in the menu will be described.

A button 706 is a button for uploading the image data received from the digital camera 100 to a social network service (SNS) via the Internet. The user of the mobile phone 200 sets an SNS of an uploading destination beforehand. When the button 706 is selected, processing for transmitting the image data to a server provided by the SNS is started. Processing for setting the SNS of the uploading destination can be started in response to selection of the button 706.

A button 707 is a button for uploading the image data received from the digital camera 100 to a content server. The user of the mobile phone 200 sets a content server of an uploading destination beforehand. When the button 707 is selected, processing for transmitting the image data to the content server via the Internet is started. Processing for setting the content server of the uploading destination can be started in response to selection of the button 707.

A button 708 is a button for attaching the image data received from the digital camera 100 to mail to transmit it. When the button 708 is selected, the control unit 201 activates a mail application to provide a pattern of mail having the received image data attached thereto. The user of the mobile phone 200 can transmit, after inputting a desired sentence, the mail to an arbitrary address via the Internet.

A button 709 is a button for recording the image data received from the digital camera 100 in the recording medium 210. When the button 709 is selected, the image data received from the digital camera is recorded in the recording medium 210.

A button 710 is a cancel button. When this button is selected, the menu illustrated in FIG. 7D is deleted, and the display returns to the state illustrated in FIG. 7C.

Then, in step S607, the control unit 210 determines whether any one of the buttons 706 to 709 among the buttons illustrated in FIG. 7D has been selected. When it is determined that one of the buttons 706 to 709 has been selected (YES in step S607), the processing proceeds to step S608. When it is determined that the button 710 has been selected (NO in step S607), the processing returns to step S606.

In step S608, the control unit 201 requests the image data corresponding to the thumbnail selected in step SD605, from the digital camera 100. After the digital camera 100 has transmitted the image data to the mobile phone 200 in response to the request, the mobile phone 200 receives the image data to store it in the work memory 204. During reception of the image data, a screen illustrated in FIG. 7E is displayed on the display unit 206. The user of the mobile phone 200 can cancel the reception by selecting a button 712 illustrated in FIG. 7E.

After the reception of the image data has been completed, the processing proceeds to step S609, and the control unit 201 determines which processing has been selected in step S607. When it is determined that one of the buttons 706, 707, and 708 has been selected, in other words, an operation of transmitting the received image data to the outside has been selected, the processing proceeds to step S611. On the other hand, when it is determined that the button 709 has been selected, in other words, an operation of storing the received image data in the recording medium 210 without transmitting it to the outside has been selected, the processing proceeds to step S610.

First, a case where the processing proceeds to step S610 will be described. In step S610, the control unit 201 stores the image data received in step S608 from the work memory 204 in the recording medium 210, and the processing is ended.

Next, a case where the processing proceeds to step S611 will be described. In step S611, the control unit 201 determines whether a network it is currently participating in is a network formed by the simple AP function of the digital camera 100. The control unit 201 performs the determination of this step by referring to the notification received from the digital camera in step S406 illustrated in FIG. 4. When it is determined that the network is not a network formed by the simple AP function of the digital camera 100 (NO in step S611), the processing proceeds to step S612. When it is determined that the network is a network formed by the simple AP function of the digital camera 100 (YES in step S611), the processing proceeds to step S613.

First, a case where the processing proceeds to step S612 from step S611 will be described. In this case, the control unit 201 determines that the network in which the own device is currently participating, is a network formed not by the simple AP function but by an external AP. In other words, a connection state similar to that illustrated in FIG. 3A is determined. In this case, the mobile phone 200 can transmit the image data via the external AP. The control unit 201 accordingly transmits predetermined transmission destination information (uniform resource locater (URL) or mail address) received via the Internet and the image data received in step S608, to the external AP. Thus, the image data is transmitted from the external AP to a predetermined transmission destination.

Next, a case where the processing proceeds to step S613 from step S611 will be described. In this case, the control unit 201 determines that a current connection form is similar to that illustrated in FIG. 3B. In this case, the mobile phone 200 cannot transmit the image data to an external network via the AP while it is connected to the network formed by the AP. Accordingly, in step S621, the mobile phone 200 exits from the network in which it is currently participating to cut off the connection with the AP (digital camera 100).

Then, in step S622, the control unit 201 controls the connection unit 211 to perform surrounding wireless network searching processing. In step S623, the control unit 201 determines whether any wireless network other than the ESSID stored in the work memory 204 (external AP other than simple AP generated by digital camera 100) has been detected in step S574. An object of detecting the wireless network other than the ESSID stored in the work memory 204 is as follows. That is, the network of the ESSID stored in the work memory 204 is the network of the simple AP generated by the digital camera 100 in step S406. Accordingly, an AP inhibited from connecting to the outside is detected based on the ESSID.

The processing proceeds to step S624 when it is determined that an external AP 300 other than the simple AP has been detected (YES in step S623), and to step S625 when not (NO in step S623).

In step S624, the control unit 201 performs connection processing on the external AP 300 other than the simple AP generated by the digital camera 100. Further, to enable communication with the other device, the control unit 201 performs IP address allocation and sub-network setting, and the processing proceeds to step S626. For selection of the external AP 300 other than the simple AP, the control unit 201 stores a wireless parameter of an external AP 300 connected in the past in the nonvolatile memory 203 beforehand, and its history information can be used. Specifically, when an external AP 300 corresponding to the wireless parameter stored as the history information in the nonvolatile memory 203 is found as a result of the wireless network searching in step S622, connection can be made to the external AP 300.

In step S625, since no external AP 300 other than the simple AP is present around the mobile phone 200, the control unit 201 controls the public network connection unit 212 to perform connection processing of a public network, and the processing proceeds to step S626. In other words, whichever of steps S624 and S625 the processing proceeds to, the control unit 201 performs control to inhibit connection to the last connected simple AP.

In step S626, the control unit 201 reads the image data received from the digital camera 100 and stored in the work memory 204, and controls the connection unit 211 or the public network connection unit 212 to transmit the image data to the outside. FIGS. 7F and 7G illustrate screens displayed on the display unit 206 during the processing in step S626. The screen illustrated in FIG. 7F is a screen when the processing proceeds to step S626 via step S625, and connection cut off from the network formed by the digital camera 100, in which the mobile phone 200 has participated thus far, is notified to the user by a dialog 713. Further, ongoing transmission of the image data carried out by another communication method is notified to the user by a dialog 714. A reason for this is as follows. When only the dialog 713 is displayed, there is a possibility that the user may think he will not be able to transmit the image data in this state. Thus, in the present exemplary embodiment, a dialog indicating ongoing transmission is displayed together with a dialog indicating cutting-off of the network. The screen illustrated in FIG. 7G is a screen when the processing proceeds to step S626 via step S624. On this screen, changing of a network from the network formed by the simple AP 300 to the network “NETWORK-100” formed by the external AP 300 is notified to the user by a dialog 715. Further, ongoing transmission of the image data carried out by another communication method is notified to the user by a dialog 716. Accordingly, the network used to transmit the image data can be notified to the user. When it is determined that the user is using an unintended network, the transmission can be canceled by selecting the button 712.

Then, in step S627, the control unit 201 determines whether the transmission processing has been completed. When it is determined that the transmission processing has been completed (YES in step S627), the processing proceeds to step S628. When not (NO in step S627), the processing is repeated. FIG. 7H illustrates a screen when it is determined in step S627 that the transmission processing has been completed. On the screen illustrated in FIG. 7H, the transmitted image is displayed, and completion of image transmission is notified to the user by a dialog 717.

After the image transmission has been completed, in step S628, the control unit 201 controls the connection unit 211 to perform surrounding wireless network searching processing. In step S629, the control unit 201 determines whether any wireless network of the ESSID stored in the work memory 204 (simple AP generated by digital camera 100) has been detected in step S574. The processing proceeds to step S630 when it is determined that the network of the simple AP generated by the digital camera 100 has been detected (YES in step S629), and the processing is ended when not (NO in step S629).

In step S630, the control unit 201 exits from the currently connected network of the external AP 300 to perform connection processing to the simple AP generated by the digital camera 100. FIG. 71 illustrates a screen when the connection to the network of the simple AP is carried out in step S631. On the screen illustrated in FIG. 71, changing of the network from the network “NETWORK-100” formed by the external AP 300 that has participated thus far to the network “CAMERA-123” formed by the digital camera 100 is notified by a dialog 718. A menu screen for controlling the digital camera 100 is displayed together with the dialog 718 on the display unit 206. This enables the mobile phone 200 to connect again to the network formed by the digital camera 100 after it has transmitted the image by using the external AP 300 or the public network. Thus, the user of the mobile phone 200 can view the image in the digital camera 100 again to perform an operation of transmitting another image to the external network.

A method for exiting from the network without making a determination in step S611, may be employed when data cannot be transmitted for a certain period of time or a certain number of times in step S612. In this case, however, there is a high possibility of taking a long time to exit from the network, which may increases the amount of communication. Thus, it is more desirable to transmit a notification as to whether the network has been formed by the simple AP from the digital camera 100 to the mobile phone 200 beforehand.

In addition, before transmission of the image data in step S626, a screen for adding a comment or a title to the image data or performing SNS setting (e.g., selection of an album or disclosure range) can be displayed.

The example where one image data is received from the digital camera 100 and transmitted from the mobile phone 200 has been described. However, a plurality of image data can be selected to be received by the mobile phone 200, and then sequentially transmitted to the external network. Alternatively, after the image data have been received, which of the image data is transmitted from the mobile phone 200 can be selected.

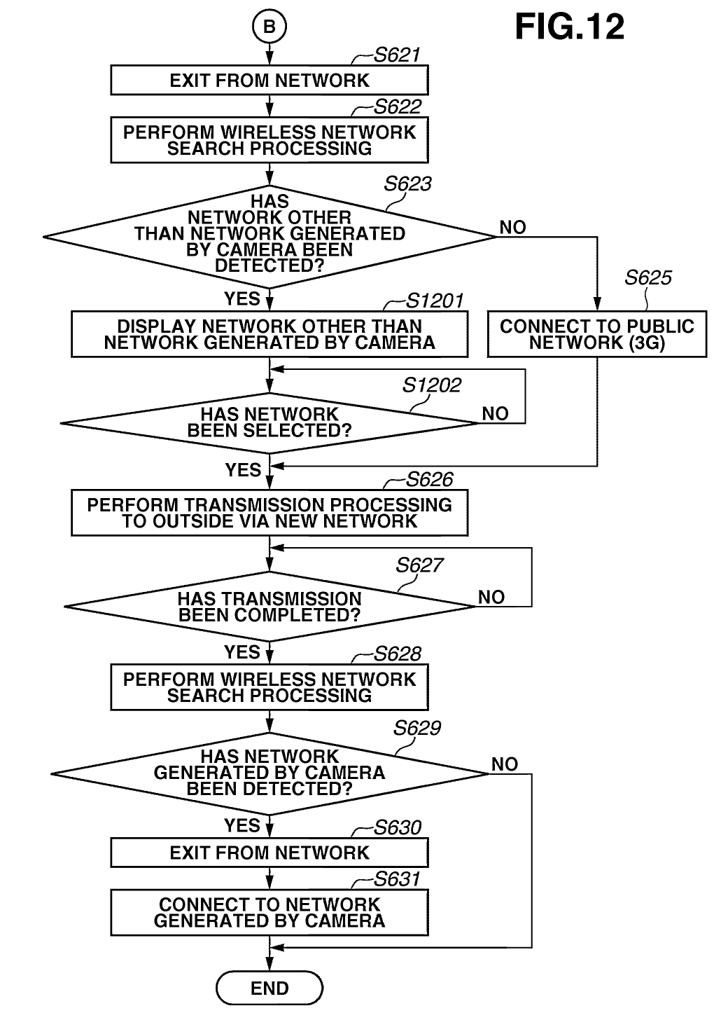

Unless otherwise specified, processing illustrated in FIG. 12 is automatically performed by the mobile phone 200 without any user's operation. However, it can be configured such that a user's operation is accepted using an appropriate dialog.

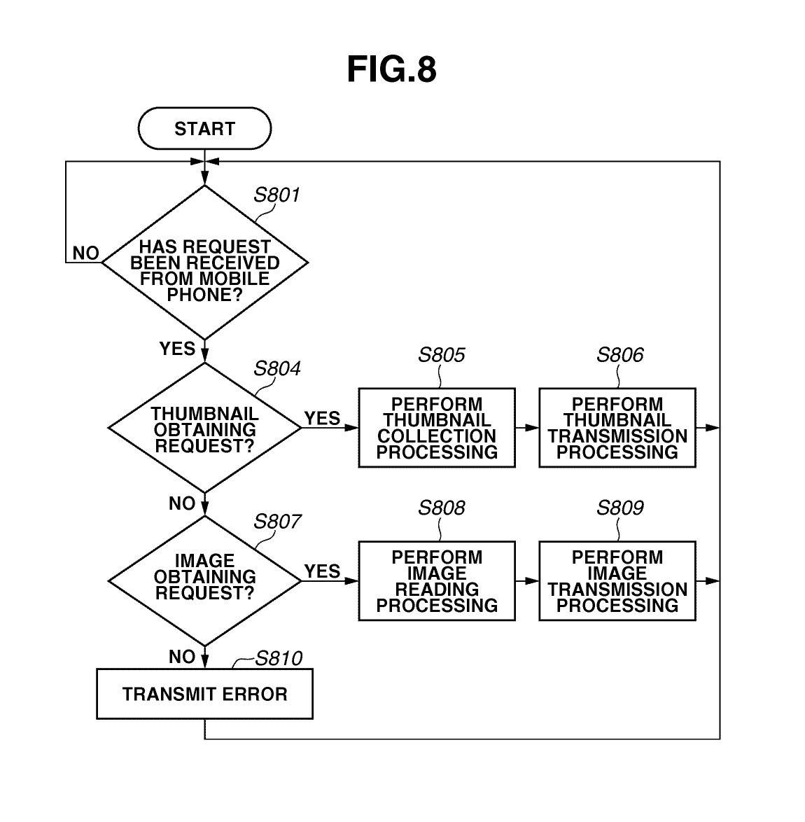

The operation of the mobile phone 200 after the connection with the digital camera 100 has been described. Next, a detailed operation performed on the digital camera 100 side will be described. FIG. 8 is a flowchart illustrating the operation of the digital camera 100 after connection with the mobile phone 200.

In step S801, the control unit 101 of the digital camera 100 determines whether a request has been received from the mobile phone 200 via the connection unit 111. The processing proceeds to step S804 when it is determined that a request has been received (YES in step S801). The processing is repeated when not received (NO in step S801). A request possibly received in this case is a request for the thumbnails transmitted in step S602 or a request for the image data transmitted in steps S607 to S608.

A case where the processing proceeds to step S804 will be described. In step S804, the control unit 101 determines whether the request received in step S801 is a thumbnail request (request transmitted in step S602). When it is determined that the request is a thumbnail request (YES in step S804), the processing proceeds to step S805. When determined otherwise (NO in step S804), the processing proceeds to step S807.

A case where the processing proceeds to step S805 will be described. In step S805, the control unit 101 searches for, among image data stored in the recording medium 110, image data requested from the mobile phone 200, and reads a thumbnail corresponding to the retrieved image data into the work memory 104. A plurality of thumbnails can also be read. In this case, a thumbnail already associated with the image data can be used or a new thumbnail can be generated.

In step S806, the control unit 101 transmits the thumbnail stored in the work memory 104 to the mobile phone 200 that has requested the thumbnail, and the processing returns to step S651. As a result of this processing, on the mobile phone 200 side, thumbnail reception processing of step S603 is performed. The processing of transmitting the thumbnail from the digital camera 100 to the mobile phone 200 has been described.

A case where the processing proceeds to step S807 will be described. In step S807, the control unit 101 determines whether the request received in step S801 is a request for image data corresponding to the thumbnail (request transmitted in step S607). When it is determined that the request is a request for image data (YES in step S807), the processing proceeds to step S808. When determined otherwise (NO in step S807), the processing proceeds to step S810.

First, a case where the processing proceeds to step S808 will be described. In step S808, the control unit 101 searches for requested image data among the image data stored in the recording medium 110, and reads the retrieved image data into the work memory 104.

Then, in step S809, the control unit 101 transmits the image data stored in the work memory 104 to the mobile phone 200, and the processing returns to step S801. As a result of this processing, on the mobile phone 200 side, image data reception processing of step S608 is performed.

On the other hand, when the processing proceeds to step S810, the control unit 101 determines that the own device cannot appropriately respond to the received request and transmits an error notification to that effect, to the digital camera 100.

The processing of transmitting the image data from the digital camera 100 to the mobile phone 200 has been described.

### Outline of Operation

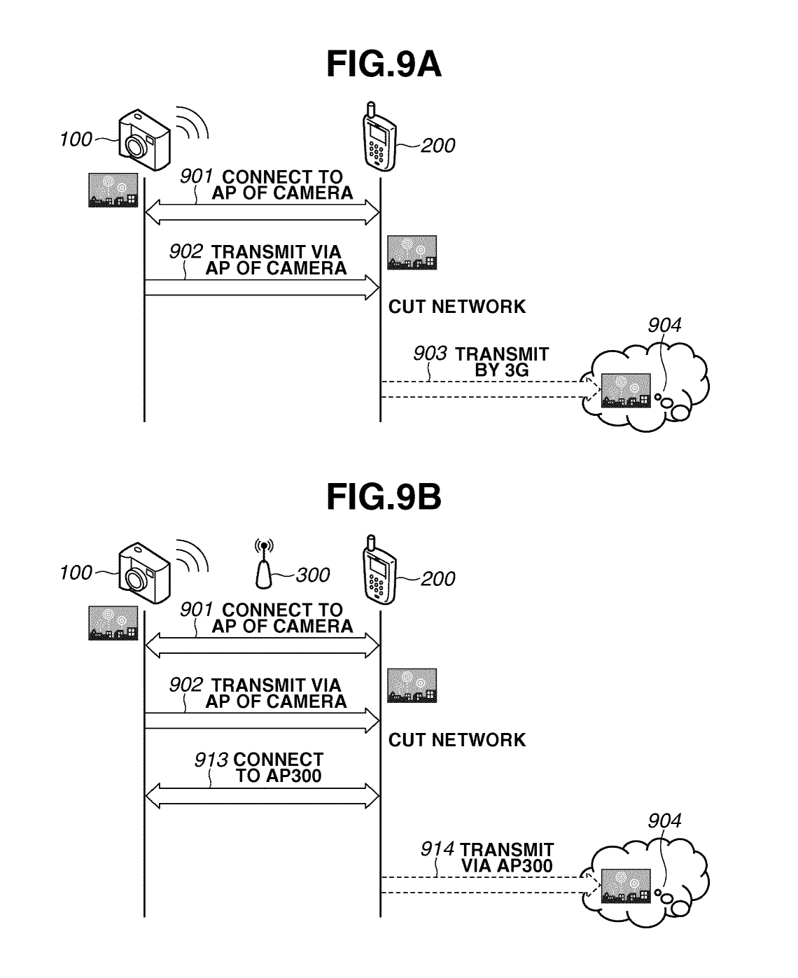

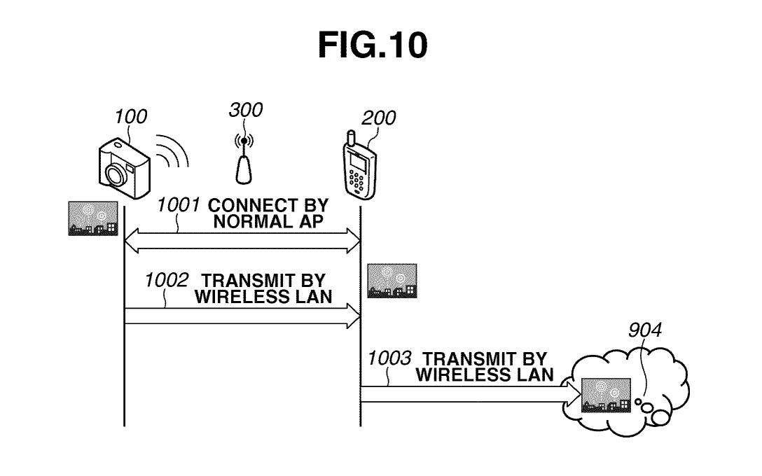

Hereinafter, outlines of the processes illustrated in FIGS. 6A and 6B and FIG. 8 will be described referring to FIGS. 9A and 9B and FIG. 10. FIGS. 9A and 9B and FIG. 10 illustrate outlines of the processes when the mobile phone 200 receives the image data from the digital camera 100, and transmits the received image data to the Internet 904.

First, referring to FIG. 9A, the case where the digital camera 100 operates as the AP (step S402 illustrated in FIG. 4) will be described. In this case, at timing 901, the digital camera 100 and the mobile phone 200 participate in the network formed by the digital camera 100 to establish communication. In this case, the mobile phone 200 stores the ESSID of the network formed by the digital camera 100 with which the communication has been established. Further, the digital camera 100 transmits a notification as to whether a current network is a network formed by itself, to the mobile phone 200 (step S406 illustrated in FIG. 4).

At timing 902, the digital camera 100 transmits the image data it owns to the mobile phone 200 via the wireless LAN formed by itself. The mobile phone 200, which then transmits the received image data to the Internet 904, has recognized in advance from the received notification that the current network is a network formed by the digital camera 100. At timing 903, the mobile phone 200 exits from the network formed by the digital camera 100, and transmits the image data to the Internet 904 via the public line network using the 3G. The outline of the operation when the digital camera 100 operates as the AP has been described.

As the operation when the digital camera 100 operates as the AP, a form illustrated in FIG. 9B is also conceivable. In the form illustrated in FIG. 9B, after the exit from the network at the timing 903, if there is a surrounding external AP 300, the mobile phone 200 participates in a network formed by the external AP 300. Then, at timing 914, the mobile phone 200 transmits the image data to the Internet 904 via the external AP 300. To make a connection to the external AP 300 in this case, the mobile phone 200 searches for a wireless network, and if a wireless network other than the ESSID stored at the timing 901 is present, may connect to the wireless network. An advantage of the operation illustrated in FIG. 9B is as follows. When communication is carried out between the digital camera 100 and the mobile phone 200, a communication speed is faster in direct communication between the digital camera 100 and the mobile phone 200 than communication via the external AP in many cases. Thus, when data communication is made between the digital camera 100 and the mobile phone 200, it is efficient for the mobile phone 200 to perform direct communication by using the network formed by the digital camera 100 and then participate in the network formed by the external AP at timing when data communication via the Internet is necessary. Thus, the data can be transmitted by changing the network in which the mobile phone 200 participates, from the first network to the second network.

Next, referring to FIG. 10, the case where the network formed by the external AP is used (step S407 illustrated in FIG. 4) will be described. In this case, at timing 1001, the digital camera 100 and the mobile phone 200 participate in the network formed by the external AP 300. Communication is established between the digital camera 100 and the mobile phone 200 via the external AP 300. At timing 1002, the image data is transmitted from the digital camera 100 to the mobile phone 200 via the external AP 300 and the mobile phone 200 receives the image data. The mobile phone 200 then transmits the received image data to the Internet 904. The mobile phone 200 has recognized that the current network is not a network formed by the digital camera 100 by the advance notification. At timing 1003, the mobile phone 200 transmits the image data to the external AP 300 so that the image data can be transmitted to the Internet 904. The outline of the operation when the external AP 300 is used has been described.

As described above, the digital camera 100 according to the present exemplary embodiment transmits the notification as to whether the current network is a network formed by using the simple AP function of its own device, to the mobile phone 200. The mobile phone 200 stores the ESSID of the network after the connection with the digital camera 100 has been established. When it is determined that the network has been formed by the simple AP, in the case of transmitting the image data to the outside, the connection is switched to the network other than the stored ESSID to transmit the data. This configuration enables the mobile phone to carry out appropriate processing according to a network feature.

When the network connected to the digital camera 100 is a network formed by the simple AP, its ESSID can be stored in the nonvolatile memory 203 each time. In the case of transmitting the image data to the outside thereafter, connection can be made to a wireless network other than the ESSID of the simple AP stored in the nonvolatile memory 203. Accordingly, in the case of transmitting the image data to the outside, wireless connection can be established excluding all simple APs connected in the past. A designated rule can be set for the ESSID of the simple AP formed by the digital camera 100, and the mobile phone 200 can connect to a wireless network of ESSID other than the designated rule when transmitting the image data to the outside. For example, the designated rule for the ESSID of the simple AP formed by the digital camera 100 is set to “CAMERA-xxx” so that first six characters can always be “CAMERA”. Then, when transmitting the image data to the outside, the mobile phone 200 can prevent connection to the simple AP by connecting to a wireless network where the first six characters of ESSID are other than “CAMERA”.

The present exemplary embodiment is directed to the configuration where the user instructs transmission of the image data from the digital camera 100 to the mobile phone 200 or transmission of the image data to the Internet by operating the mobile phone 200. However, the user can instruct transmission of the image data to the mobile phone 200 or transmission of the image data to the Internet from the mobile phone 200 by operating the digital camera 100.

The present exemplary embodiment is directed to the configuration where the digital camera 100 forms the network to directly communicate with the mobile phone 200. However, the present invention can be applied to a connection form where the devices communicate with each other beforehand so that one of them can be an AP as in the case of Wireless-Fidelity (Wi-Fi) Direct.

The present exemplary embodiment has been described by taking the example where the control is performed to switch the network when the mobile phone 200 transmits the image data received from the digital camera 100 via the Internet. However, the application range of the present invention is not limited to this. For example, when it is determined that the network in which the device is currently participating is a network formed by the digital camera 100, similar control can be performed when the mobile phone 200 uses an application using the Internet such as a web browser or electronic mail of the own device.

The first exemplary embodiment has been directed to the form where the connection is automatically switched to the network of the external AP when the connected network is a network formed by the simple AP during transmission of the image data from the mobile phone 200 to the outside. However, there may be a case where a user may wish to explicitly select a wireless network to be connected, for example, a case where the user wishes to use a securer wireless network among a plurality of wireless networks. In the present exemplary embodiment, in such a case, the user can connect to an intended wireless network to carry out appropriate processing.

The second exemplary embodiments has many components similar to those of the first exemplary embodiment. Thus, description of the similar components will be omitted, and only portions unique to the present exemplary embodiment will be described.

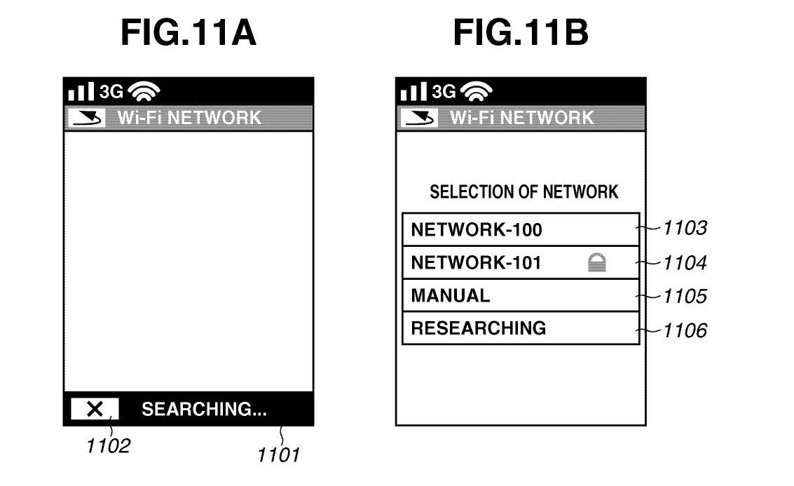

FIGS. 11A and 11B are diagrams each illustrating an example of a display screen according to the present exemplary embodiment. FIG. 12 is a flowchart illustrating an operation of the mobile phone 200 according to the present exemplary embodiment. This flowchart concerns processing after connected with the digital camera 100. Steps similar to those illustrated in FIG. 6B are denoted by similar numerals. A difference from the flowchart illustrated in FIG. 6B is processing of steps S1201 and S1202. Hereinafter, steps S1202 and S1202 will be described.

When the processing proceeds to step S1201, a control unit 201 displays, from a search result in step S622, a list of external APs other than a simple AP generated by the digital camera 100 on a display unit 206. FIG. 11B illustrates its display screen. On the display screen, an ESSID list of networks (APs other than simple AP generated by digital camera 100) excluding ESSID stored in a work memory 204 in step S574 is displayed as buttons 1103 and 1104 on the display screen, from the network search result. In FIG. 11B, a button 1105 for manually setting a network parameter is displayed. When no desired network can be retrieved as a result of network searching in step S622, the user carries out wireless connection by manually setting a wireless parameter. A button 1106 is for performing network re-searching. When the user selects the button 1106, the control unit 201 controls a connection unit 211 to perform wireless network searching.

When the control unit 201 determines that one of the buttons 1103 to 1106 illustrated in FIG. 11B has been selected (YES in step S1202), the processing proceeds to step S626. When not selected (NO in step S626), the processing is repeated.

The operation of the mobile phone 200 according to the present exemplary has been described.

As described above, according to the present exemplary embodiment, the user can select a network to be connected during transmission of the image data to the outside. Thus, the image data can be transmitted by selecting and connecting to a more secure network among, for example, connectable networks. In this case, the network of the simple AP formed by the digital camera 100 can be excluded from connection candidates. Thus, a possibility of connecting to a network unconnectable to the outside can be eliminated.

### Other Embodiments

The object of the present invention can also be achieved as follows. A storage medium (or recording medium) recording software program codes for realizing the functions of the exemplary embodiments is supplied to a system or an apparatus. Then, a computer (central processing unit (CPU) or microprocessor unit (MPU)) of the system or the apparatus reads the program codes stored in the storage medium to execute them. In this case, the program codes read from the storage medium realize the functions of the exemplary embodiments themselves, and the storage medium storing the program codes constitutes the present invention. By executing the program codes read by the computer, the functions of the exemplary embodiments can not only be realized but also achieved as follows. That is, based on instructions of the read program codes, an operating system (OS) operating on the computer carries out a part or all parts of actual processing, thereby realizing the functions of the exemplary embodiments. The storage medium storing the program codes may be selected from, for example, a flexible disk, a hard disk, a read-only memory (ROM), a random access memory (RAM), a magnetic tape, a nonvolatile memory card, a compact disk (CD)-ROM, a CD-R, an optical disk, and a magneto-optical (MO) disk. Further, a computer network such as LAN or wide area network (WAN) can be used for supplying the program codes.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-268541 filed Dec. 7, 2012, which is hereby incorporated by reference herein in its entirety.

What is claimed is:

1. A communication apparatus capable of participating in a network formed by a relay apparatus, comprising:
a data communication unit configured to perform data communication with a data processing apparatus by establishing communication with the data processing apparatus via a first network;
a reception unit configured to receive, from the data processing apparatus, a notification indicating whether the data processing apparatus has formed the first network as the relay apparatus;
a control unit configured to control transmission or reception of data via the Internet; and
a network changing unit configured to search, when the notification indicating that the data processing apparatus has formed the first network as the relay apparatus is received, for surrounding networks, eliminate the first network from a search result, and participate in one of remaining candidates in the search result, wherein the control unit transmits or receives data via the Internet by using the changed network.

2. The communication apparatus according to claim 1, wherein when the reception unit receives the notification indicating that the data processing apparatus has not formed the first network as the relay apparatus, the control unit control to transmit or receive the data via the Internet by way of a relay apparatus that forms the first network.

3. The communication apparatus according to claim 1, wherein when the reception unit receives the notification indicating that the data processing apparatus has formed the first network as the relay apparatus, the control unit controls to cause the communication apparatus to participate in a second network different from the first network.

4. The communication apparatus according to claim 3, wherein:
the second network is a public network; and
the control unit performs control to transmit or receive of the data via the Internet by using the second network.

5. The communication apparatus according to claim 4 wherein the public network is a network based on 3G or LTE.

6. The communication apparatus according to claim 3, wherein:
the second network is a network formed by a relay apparatus different from the relay apparatus that forms the first network; and
the control unit performs control to transmit or receive of the data via the Internet by using the second network.

7. The communication apparatus according to claim 1, wherein when the reception unit receives the notification indicating that the data processing apparatus has formed the first network as the relay apparatus, the control unit causes the communication apparatus to exit from the first network.

8. The communication apparatus according to claim 1, wherein the data processing apparatus includes no unit to connect to a public network.

9. The communication apparatus according to claim 1, wherein the data processing apparatus has no gateway function.

10. The communication apparatus according to claim 1, wherein the data communication unit can perform data communication with the data processing apparatus by establishing communication with the data processing apparatus via the first network formed by a relay apparatus that includes a unit to connect to a public network.

11. The communication apparatus according to claim 1, wherein the data communication unit can perform data communication with the data processing apparatus by establishing communication with the data processing apparatus via the first network formed by a relay apparatus that has a gateway function.

12. The communication apparatus according to claim 1, wherein the relay apparatus is an access point in a wireless LAN.

13. The communication apparatus according to claim 1, wherein the communication apparatus is a mobile phone.

14. The communication apparatus according to claim 1, further comprising;
a unit configured to store a communication parameter of the first network.

15. The communication apparatus according to claim 1, wherein the communication apparatus further comprising;
a display unit configured to display a list of at least one of the remaining candidates in the search result.

16. The communication apparatus according to claim 1, wherein after the network changing unit changes the network and the control unit controls to transmit or receive the data via the Internet, the network changing unit searches for surrounding networks and participates in the first network.

17. A method for controlling a communication apparatus capable of participating in a network formed by a relay apparatus, comprising:
performing data communication with a data processing apparatus by establishing communication with the data processing apparatus via a first network;
receiving, from the data processing apparatus, a notification indicating whether the data processing apparatus has formed the first network as the relay apparatus;
searching, when the notification indicating that the data processing apparatus has formed the first network as the relay apparatus is received and data is transmitted or received via the Internet, for surrounding networks, eliminating the first network from a search result, and participating in one of remaining candidates in the search result; and
transmitting or receiving the data via the Internet by using the changed network.

18. A computer readable recording medium storing a program that causes a computer to function as a communication apparatus of claim 1.
